(19) United States
(12) Patent Application Publication
(10) Pub. No.: US 2020/0363808 A1
(43) Pub. Date: Nov. 19, 2020

(54) Retrotraverse of Autonomous Vehicles without Pinning or with Automatic Pinning

(71) Applicants: Alberto Daniel Lacaze, Potomac, MD (US); Karl Nicholas Murphy, Rockville, MD (US)

(72) Inventors: Alberto Daniel Lacaze, Potomac, MD (US); Karl Nicholas Murphy, Rockville, MD (US)

(73) Assignee: Alberto Daniel Lacaze, Gaithersburg, MD (US)

(21) Appl. No.: 16/409,981

(22) Filed: May 13, 2019

(51) Int. Cl. G05D 1/02; G05D 1/00; B60W 30/18

(52) U.S. Cl. CPC G05D 1/0214; G05D 1/024; G05D 1/0257; B60W 2300/145; B60W 30/18036; G05D 2201/0213; G05D 1/0088

(57) ABSTRACT

The present invention describes a system that is developed for autonomically backing up a tractor-trailer that consists of a tractor, a trailer, a sensor suite that measures the angle between the tractor and the trailer as well as the area suitable for backing up and a planning algorithm test generating a trajectory to back up or turn around the tractor-trailer without the use of pins or with automatic pinning. A genetic algorithm has been developed to determine the best trajectory for the convoy of autonomous vehicles to take from the starting position to the final position in the road network. In addition, other methods such as dynamic programming and other graph optimization methods can also be used to determine the best trajectory for the convoy of autonomous vehicles to take to reach the final destination point. Pose determination of the location of the trailer and the link can be performed using the sensor on the tractor side without having to add sensors to the trailer to significantly improve the cost and usability of the system. A method has been developed to design an autonomous pinning mechanism. Also, the genetic algorithms, dynamic programming, or other graph optimization programs for backing occurs with the double-jointed unpinned trailer while avoiding detecting the trailer except for ground truth. The genetic algorithms, dynamic programming, or other graph optimization programs are used to find the best trajectory from the initial position of the convoy of autonomous vehicles to the final position of the convoy of autonomous vehicles after retrotraverse or straight-line backing.

### CROSS-REFERENCES TO OTHER APPLICATIONS

None.

### BACKGROUND OF THE INVENTION

### 1. Field of the Invention

The present invention relates to the development of a system for automatically backing up a tractor-trailer that comprises a tractor, a trailer, a sensor suite allowing for the measurement of the angle between the tractor and the trailer as well as the measurement of the area suitable for backing up and a planning algorithm test generating a trajectory to back up or turn around the tractor-trailer. Retrotraverse or straight line backing of autonomous vehicles occur without the use of pinning or by the use of automatic pinning and involves a design that ultimately automatically pins the trailer. In addition, a method has also been developed to design an autonomous pinning mechanism. A genetic algorithm, dynamic programming, or other graph optimization program is used to find the best trajectory for the convoy of autonomous vehicles to go from the initial starting point to the final ending destination. The genetic algorithms, dynamic programming, or other graph optimization programs for backing also occurs with double-jointed unpinned trailer while avoiding detecting the trailer except for the ground truth. The genetic algorithm, dynamic programming, or other graph optimization program is used to find the best trajectory for a convoy of autonomous vehicles to take from the initial position to the final position.

### 2. Description of Related Art

The statements in this section merely provide background information related to the present disclosure and may not constitute prior art.

There have not been any reports in the literature of any types of sensors that are designed for automatically backing up a tractor-trailer and no algorithms have been developed for finding the best trajectory for the convoy of autonomous vehicles to go from the initial starting position to the final ending position.

There has been a system and method developed to remotely control an autonomous vehicle as shown in AU Patent No. 2015202581A1. This system increases the operator's situational awareness while the operator controls a remote vehicle. There is an operator control unit with a point-and-click interface configured to allow an operator to view an environment surrounding the remote vehicle and control the remote vehicle and the operator control unit.

There have been a couple of patents related to a method for enhancing operating efficiency of a remote vehicle using a diagnostic behavior as shown in U.S. Pat. Nos. 8,396, 611 and 8,326,469. The method involves inputting and analyzing data received from a plurality of sensors to determine the existence of deviations from normal operations of the vehicle, updating parameters in a reference mobility model based on deviations from normal operation, and revising strategies to achieve an operational goal of the remote vehicle to accommodate deviations from normal operation.

There has been a system and method developed for allowing an operator to switch between remote vehicle tele-operation and one or more remote vehicle autonomous behaviors, or for implementing remote vehicle autonomous behaviors as shown in U.S. Pat. No. 8,843,244. This system that is used comprises an operator control system receiving input from the operator as well instructions for the remote vehicle to execute autonomous behavior, and a control system on the remote vehicle.

There has been a system developed for controlling a remote vehicle that comprises a hand-held controller having many buttons, a display with a graphical user interface with soft buttons and a processor in communication with the hand-held controller and display as can be seen in U.S. Pat. No. 8,350,810. Buttons of the hand-held controller are mapped to the soft buttons of the graphical user interface to allow actuation of soft buttons of the graphical user interface and the hand-held controller is capable of switching between two or more button function modes where each button function mode assigns different functions to one or more of the buttons of the hand-held controller.

There have been mobile systems and methods that have been developed as can be seen in U.S. Pat. No. 8,122,982 in which one tracked mobile robot has a first end comprising a first pair of wheels, a second end comprising a second pair of wheels, an articulated arm coaxial with the first pair of wheels, and a driven support surface surrounding the first pair of wheels and the second pair of wheels.

There has been a remote vehicle control system and method developed as shown in US Pat. No. 9,658,615 that has an operator control unit with a point-and-click interface that allows the operator to control the remote vehicle by inputting one or more commands via the point-and-click interface. The operator control unit has a 3D local perceptual space with an egocentric coordinate system with a predetermined distance centered on the remote vehicle, a remote vehicle representation having selectable portions, and icon at a point selected in the 3D local perceptual space and at a corresponding location in the alternative view of a map having an identified current location of the remote vehicle. The system also has a payload attached to the vehicle with a computational module and an integrated sensor suite with a global positioning system, an inertial measurement unit, and a stereo vision camera.

Overall, there have been no reports in the patent literature on the topic related to autonomous vehicles retrotraversing without the use of pins or with automatic pinning. There has not been any type of algorithm that has been developed for finding the best trajectory for the convoy of autonomous vehicles to take to go from the initial starting position to the final ending position during retrotraverse or straight-line backing.

### SUMMARY OF THE INVENTION

A system has been developed for automatically backing up a tractor-trailer that comprises a tractor, a trailer, a sensor suite allowing the measurement of the angle between the tractor and the trailer and also the area suitable for backing up as well as a planning algorithm test generating a trajectory to back up or turn around the tractor-trailer.

A genetic algorithm, dynamic programming, or other graph optimization program has been developed to find the best trajectory for the convoy of autonomous vehicles to take from the initial starting position to the final ending position while retrotraversing or straight-line backing.

The genetic algorithm, dynamic programming, or other graph optimization program is used to plot many different trajectories from the initial starting point of the convoy of autonomous vehicles to the final ending point of the convoy of autonomous vehicles and also finds the best trajectory for the convoy of autonomous vehicles to take to reach the final destination.

The genetic algorithm, dynamic programming, or other graph optimization program is also used for double-jointed unpinned trailers without detecting trailer except the ground truth.

### BRIEF DESCRIPTION OF THE DRAWINGS

The present invention is described in the detailed description that follows, with reference to the following noted drawings that illustrate non-limiting examples of embodiments of the present invention, and in which like reference numerals represent similar parts throughout the drawings.

FIG. 1. Illustration of autonomous vehicles being unpinned (101,102) and pinned (103,104) to each other. The figures shown here distinguish the difference between the two types of arrangements in tractor-trailers.

FIG. 2. Illustrations of the different angles that are measured for both the case of the unpinned and pinned tractor-trailers and also in the case where there are multiple trailers. The tractors are illustrated as 201, 302, 203, 204, and 205. The trainers are indicated as 206, 207, 208, 209, and 210.

FIG. 3. An example of a trajectory (302) that the convoy of autonomous vehicles (301) must take to undergo straight-line backing from the starting point to the final ending point of the road network (300).

FIG. 4. An example of the best trajectory found by the genetic algorithm, dynamic programming, or other graph optimization program for the convoy of autonomous vehicles to take for retrotraversing or straight line backing from the initial starting point to the final ending destination point.

### DETAILED DESRIPTION OF THE INVENTION

Elements in the Figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

Unless specifically set forth herein, the terms “a,” “an,” and “the” are not limited to one element, but instead should be read as meaning “at least one.” The terminology includes the words noted above, derivatives thereof, and words of similar import.

The particulars shown herein are given as examples and are for the purposes of illustrative discussion of the embodiments of the present invention only and are presented in the cause of providing what is believed to be the most useful and readily understood description of the principles and conceptual aspects of the present invention.

The term, pinning, refers to locking either joint in tractor-trailer. In this case, the straight-line backing is done without pinning or with automatic pinning.

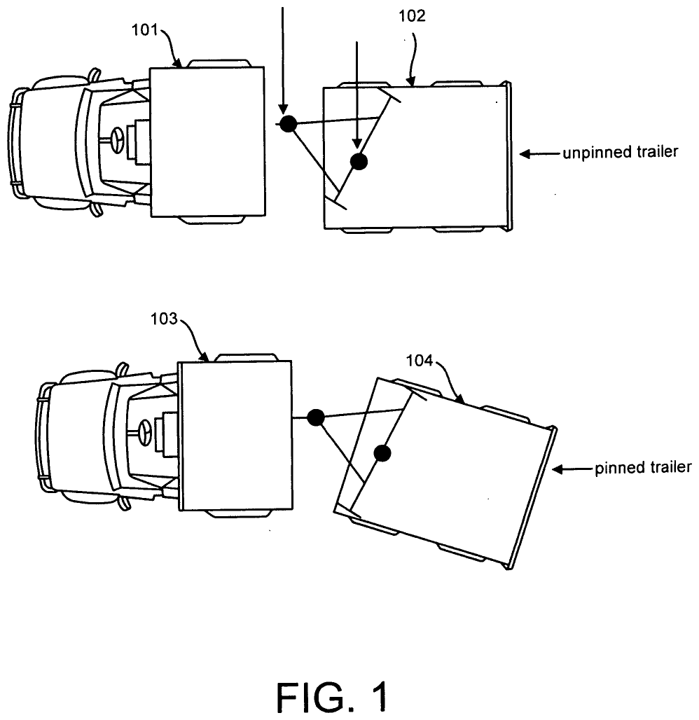

FIG. 1 illustrates a case where the tractor is pinned to the trailer and a case where the tractor is unpinned to the trailer. The pinning and lack of pinning is clearly illustrated in the figures that are shown in FIG. 1.

A system for automatically backing up a tractor-trailer comprising a tractor, a trailer, a sensor suite allowing measurement of the angle between the tractor and the trailer and measurement of the area suitable for backing up and a planning algorithm test generating a trajectory to back up or turn around the tractor-trailer has been developed.

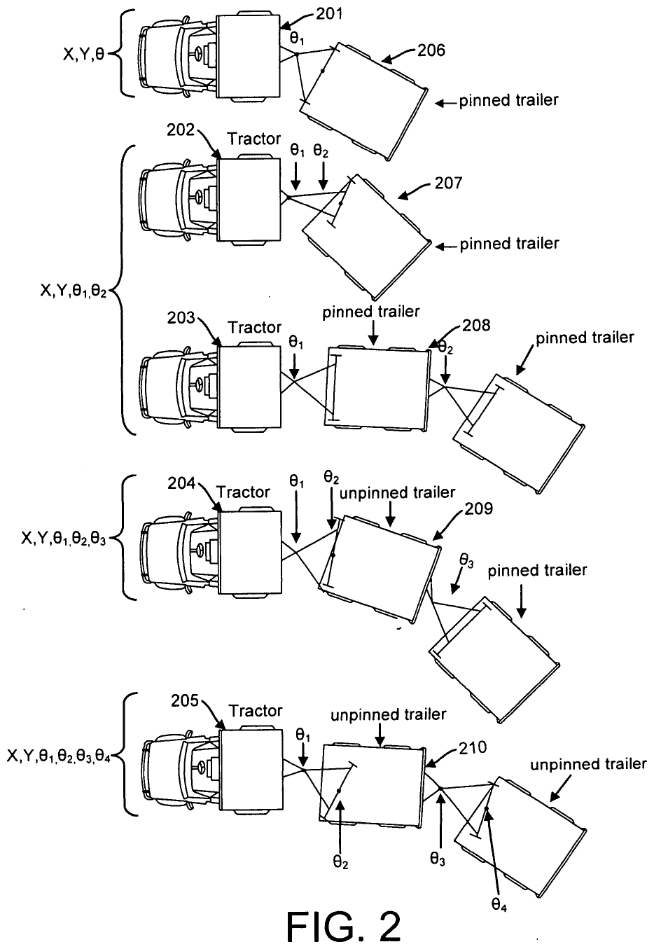

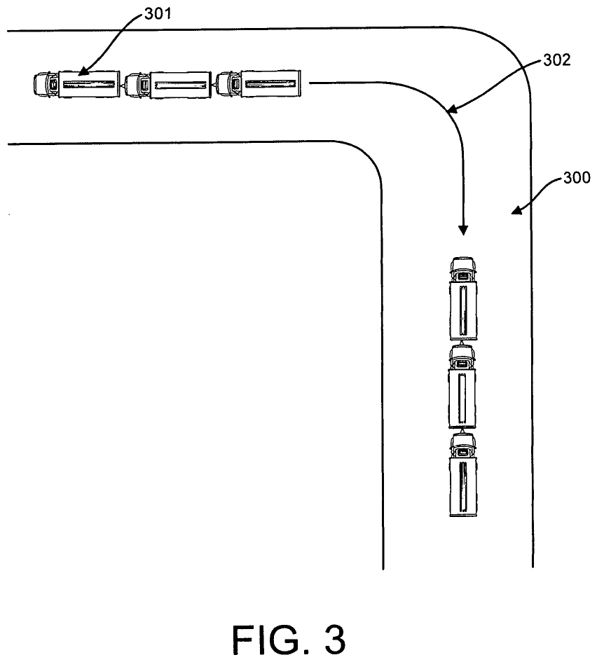

In this system, there is one tractor and two or more trailers as can be seen in FIG. 2. The convoy of autonomous vehicles are shown to retrotraverse or conduct straight-line backing automatically using a defined trajectory which is illustrated in FIG. 3.

Genetic algorithms are a type of optimization algorithms that are used to find the optimal solution to a computational problem that maximizes or minimizes a particular function. They imitate the biological processes of reproduction and natural selection to solve for the “fittest” solutions. The genetic algorithm is used to find the best trajectory for the convoy of autonomous vehicles to go from the initial starting position to the final ending position. Other algorithms are also used in this system in the present invention such as dynamic programming or other graph optimization algorithms.

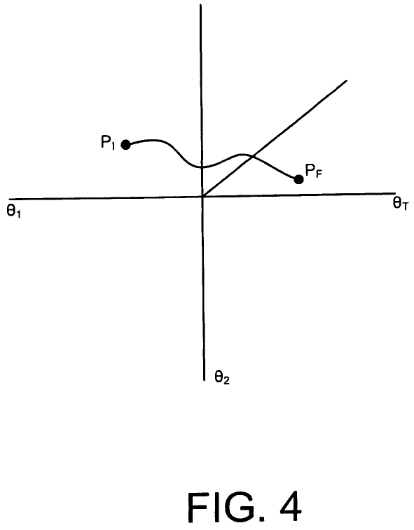

A genetic algorithm has been developed for determining the best trajectory for the convoy of autonomous vehicles to go from the initial starting point to the final ending point. In addition, dynamic programming, or a graph optimization algorithm can be used instead of a genetic algorithm to determine the best trajectory for the convoy of autonomous vehicles to take from the initial starting point to the final ending point. FIG. 4 illustrates an example of the best trajectory generated by the algorithm from the starting point to the ending point. Instrumentation of the trailer will be used only for the ground truth. The determination of the location of the trailer and the link can be performed using the sensor on the tractor side without having to add sensors to the trailer. This significantly improves the cost and usability of the system.

The genetic algorithms, dynamic programming, or other graph optimization algorithms are used to plot the wide variety of different trajectories that are possible for the convoy of autonomous vehicles to go from the starting position to the final position. The best trajectory for the convoy of autonomous vehicles to go from the initial starting position to the final destination is predicted by the genetic algorithm as illustrated in FIG. 4.

In this system, LADAR, RADAR, or stereo sensors are used to determine the areas for the convoy of autonomous vehicles to turn around or for retrotraversing or straight-line backing.

The planner searches in x and y directions as well in the different angles between the tractor and the trailer. This depends on the number of trailers that are present behind the tractor. The searches are performed in the covered space steering or steering note and acceleration/speed space. In addition, there is a simulator that verifies the outcome of providing those commands against the space available.

A method has also been designed to develop an automatic pinning mechanism.

Also, the genetic algorithms, dynamic programming, or other graph optimization algorithms occur for straight line backing or retrotraverse occurs with the double-jointed unpinned trailer while avoiding detecting the trailer except for the ground truth.

The embodiments of the invention in which an exclusive property or privilege is claimed are defined as follows:

1. A system for automatically backing up a tractor-trailer comprising:
a tractor;
a trailer;
a sensor suite that allows measurement of the angle between the tractor and the trailer;
a sensor suite that allows measurement of the area suitable for backing up;
a planning algorithm test generating a trajectory to back up or turn around the tractor-trailer.

2. The system of claim 1 wherein there is no pinning or automatic pinning.

3. The system of claim 1 wherein there is one tractor and two or more trailers.

4. The system of claim 1 wherein the algorithm used to find the trajectory is a genetic algorithm, or dynamic programming or another graph optimization algorithm.

5. The system of claim 1 wherein a LADAR or stereo pair is used to determine the area where the truck can turn around.

6. The system of claim 1 wherein the rules of the road are used to determine the areas for turning around.

7. The system of claim 1 wherein LADAR, RADAR, or stereo is used to determine if there are obstacles in the area planned to be used for turning around.

8. The system of claim 1 wherein the planner searches in x, y, and Θ.

9. The system of claim 1 wherein the planner searches in x, y, and Θ₁, Θ₂, Θ₃, etc. for unpinned trailer or multiple trailers.

10. The system of claim 1 where the search is performed in the covered space steering, or steering note and acceleration/speed space, and a simulator that verifies the outcome of providing those commands against the space available.

11. The system of claim 1 wherein the unpinned trailer is treated from a computational standpoint as a multiple trailer.

12. The system of claim 1 wherein the pose determination of the location of the trailer and the link can be performed using the sensor on the tractor side without having to add sensors to the trailers.

13. The system of claim 1 wherein an autonomous pinning mechanism is designed.
